(19) United States
(12) Patent Application Publication
(10) Pub. No.: US 2004/0104278 A1
(43) Pub. Date: Jun. 3, 2004

(54) System and apparatus for refrigeration and heating

(76) Inventor: Paul J. Walsh, Gilbert, AZ (US)

Correspondence Address: HODGSON RUSS LLP, ONE M & T PLAZA, SUITE 2000, BUFFALO, NY, 14203-2391, US

(21) Appl. No.: 10/719,920

(22) Filed: Nov. 21, 2003

Related U.S. Application Data
(60) Provisional application No. 60/428,364, filed on Nov. 22, 2002.

(51) Int. Cl. G05D 23/13; F28F 1/00; F25B 29/00; G05D 23/00

(52) U.S. Cl. 236/12.1; 165/296; 165/201

(57) ABSTRACT

An apparatus for refrigeration and heating comprising a refrigeration machine for providing cold and hot fluid, the cold and hot fluid delivered through a cold supply pipe and a hot supply/return pipe to a fan coil unit. An upstream two position three-way valve connected to the cold supply pipe and to the hot supply/return pipe, a modulating three-way mixing valve located downstream of the upstream two position three-way valve, and a fan coil unit pump located downstream of the modulating three-way mixing valve. The modulating three-way mixing valve is for allowing none, a portion of, or all of the fluid in the coil to be recirculated through the coil by the fan coil unit pump. A downstream two position three-way valve located downstream of the modulating three-way mixing valve and for returning fluid to the cold return pipe or the hot supply/return pipe. The fan coil unit for refrigerating a room or walk in cooler by pumping cold fluid through the coil. A total air pressure drop sensor to detect a pressure differential across the coil and for sensing a predetermined maximum pressure differential across the coil indicating ice blockage in the coil. Once coil blockage is detected, hot fluid from the hot supply/return pipe is automatically pumped through the coil until the fluid exiting the coil is at a predetermined temperature.

This application claims the benefit of U.S. Provisional Application No. 60/428,364 filed Nov. 22, 2002.

### BACKGROUND

There are many systems for providing refrigeration for walk in coolers, meat coolers, vegetable coolers and the like. These systems use a refrigerant that is piped to the cooler. The refrigerant absorbs heat from the cooler or room thus cooling the room or cooler. Many of these systems run a gaseous refrigerant through the pipes. However, use of gaseous refrigerants is a troublesome process because the compressors which pump the refrigerant carry over oil into the pipes and the system. Thus, oil is constantly accumulating in the system. Oil return devices are provided to collect the oil so that it can be returned to the compressor. This problem is magnified when cooling is needed hundreds of feet from the central equipment room, because there are hundreds of feet of pipe and more accumulated oil has to be returned.

Additionally, past systems using a gaseous refrigerant encountered defrosting problems when the time came to defrost the coils, which accumulate ice as time progresses. In order to defrost, hot gas is piped to the coils and frost is removed from the fins extending from the coils. A suction line returns the refrigerant and oil to the compressor. This is an undesirable duplication of piping systems, refrigerant, and oil accumulator.

There is therefore a need for a cleaner and more efficient system and methodology.

### SUMMARY

The apparatus for refrigeration and heating comprises a refrigeration machine having an evaporator and condenser. Leading from the evaporator is a cold supply pipe for delivering cold fluid and leading from the condenser is a hot supply/return pipe for delivering hot fluid. A two position three-way valve is connected to the cold supply pipe and to the hot supply/return pipe. A modulating three-way mixing valve is located downstream of the two position three-way valve.

A fan coil unit pump is located downstream of the modulating three-way mixing valve. The fan coil unit comprises a coil having sides and a fan for blowing air through the coil and the fan coil unit pump is for pumping fluid through the coil. The fan coil unit is for refrigerating the room or walk in cooler.

A two position three-way valve located downstream of the modulating three-way mixing valve, and for directing the flow of coil return water into the cold return pipe or hot supply/return pipe. Also, the modulating three-way mixing valve is for allowing none, a portion of, or all of the fluid in the coil to be recirculated through the coil by the fan coil unit pump.

A total air pressure sensor is provided and arranged so as to detect an air pressure differential across the coil for determining if there exists ice blockage in the coil. If the pressure differential detected is within acceptable levels the two position valve opens to the flow of cold fluid and the modulating three-way mixing valve opens to the flow of cold fluid and the fan coil unit pump pumps the cold fluid through the coil. But, if the pressure differential detected is not within acceptable limits, that is it is high because there is little or no air flow through the coil, then the two position three-way valve opens to the flow of hot fluid and closes to the flow of cold fluid, and hot fluid flows through the two position three-way valve, flows through the modulating three way valve, is pumped by the unit pump through the coil, and the hot fluid in the coil melts the ice on the coil. When the total air pressure sensor detects that the a pressure differential across the coil has decreased, the two position three way valve opens to the flow of cold fluid, and the fan coil unit refrigerates the room or walk in cooler.

The apparatus further comprises a cold fluid storage tank for storing cold fluid and a hot fluid storage tank for storing hot fluid. Then, when demand changes for heating or cooling the fluid in the tanks may be pumped to the condenser or evaporator decreasing the load on the refrigeration machine and decreasing power consumption costs.

The fluid may comprise synthetic fluids mixed with water, ethylene glycol which may be mixed with water, for example 50% water and 50% ethylene glycol, eutetic mixtures of phenyl ether and diphenyl, isomers of an alkylated aromatic, and blends thereof.

The apparatus has a heat rejection device comprising an evaporative cooler comprising fan and a heat rejection coil. An evaporative cooler pumps hot fluid from the condenser through the heat rejection coil. Then, sprayers spray water on the heat rejection coil to cool the hot fluid before it is returned to the condenser. Excess heat is thus rejected.

### BRIEF DESCRIPTION OF THE DRAWING

FIG. 1 is a schematic and shows the system and apparatus for refrigeration and heating.

### DESCRIPTION

The apparatus 20 overcomes problems associated with using gaseous refrigerants in the pipes of cooling systems, as has been done in the past. In particular, the present apparatus 20 uses a fluid 200 in all the equipment and piping. The fluid 200 being pumped in the apparatus 20, in a manner to be described presently, may be a synthetic fluid, ethylene glycol, for example a blend of 50% water and 50% ethylene glycol, Dowtherm SR-1 (eutetic mixture of phenyl ether and diphenyl), isomers of an alkylated aromatic (Dowtherm J); blends of any of the above; and other suitable fluids. It is noted that the mark DOWTHERM is a registered trademark mark (United States Registration Number 0941806) of:

Dow Chemical Company

The Corporation Delaware 1790

Building Washington Street

Midland, Mich. 48674.

Use of these fluids 200 avoids the problems associated with the use of gaseous refrigerants that required compressors which introduced significant amounts of oil into the pipes and equipment, causing a host of problems. Another way the apparatus 20 overcomes past problems is demonstrated when the coil 43 need to be defrosted, as this merely requires that the fluid 200 being circulated through the coil 43 be a heated fluid 200. In other words, the fluid 200 may be cold when it is used in the fan coil unit 34A to cool the room or space 90, or hot when it is used to defrost the coil 43 of the second fan coil unit 34B.

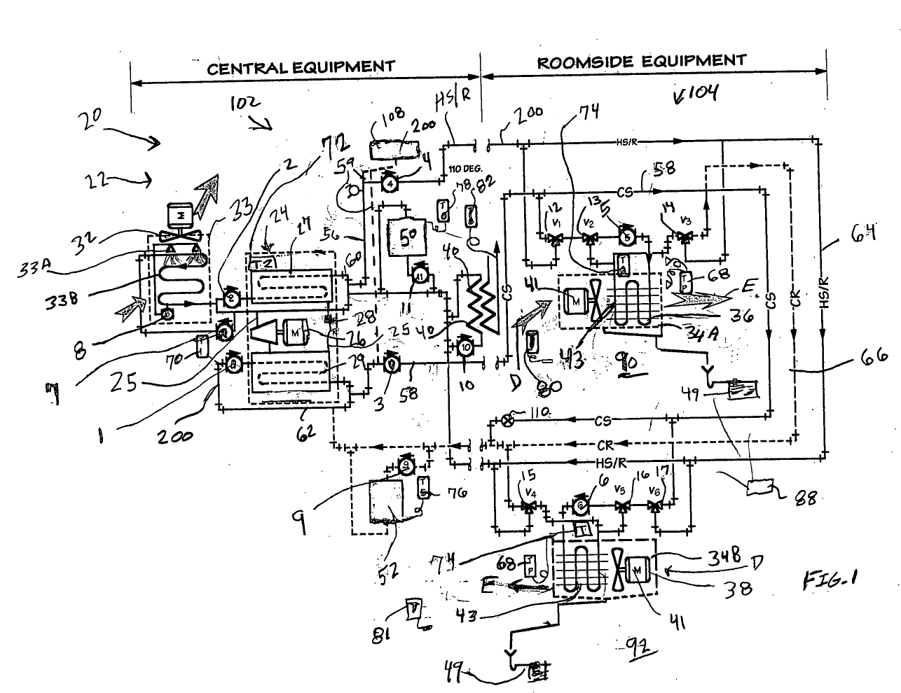

Turning to FIG. 1, on the central equipment side 102, the apparatus for refrigeration and heating 20 comprises a central equipment room 22 comprising a refrigeration machine 24. The refrigeration machine 24 comprises refrigerant piping 25 and uses a suitable refrigerant. The refrigeration machine 24 comprises a motor and compressor 26, a condenser 27, an expansion valve 28, and an evaporator 29. When the motor compressor 26 unit is activated, the compressor 26 compresses the gas vapor it draws in from the evaporator 29. Heat is generated as a byproduct of gas compression process. Thus, a high pressure hot gas exits the compressor 26 and enters the condenser 27. The heat rejection device 33 may be used to remove the heat, or the heat may be used for other purposes. After the heat is removed, the refrigerant in the pipes 25 is in liquid form and flows to the expansion valve 28. The liquid flows through the expansion valve 28 and expands and cools in the evaporator 29, thus providing a cold source. The compressor 27 draws the gas vapor back in and compresses the gas vapor into a hot gas line that enters the condenser 27, and the refrigeration machine 24 repeats this cycle. Thus, the refrigeration machine 24 provides a heat-source in that the hot gas exiting the condenser 27 has heat energy that is available for other processes; and the refrigeration machine 24 provides a cold source in that the cold vapor in the evaporator 29 may be used for cooling in other parts of the apparatus 20.

The cold fluid evaporator pump 1, pumps the fluid 200 through the evaporator 29 and the cold fluid main pump 3 pumps the cold fluid 200 through the cold supply pipe (hereinafter CS) 58. The fluid 200 in the (CS) pipe 58 may be about 10 degrees Fahrenheit after it exits the evaporator 29. The cold return pipe (hereinafter CR) 66 returns cold fluid to the evaporator 29 or cold fluid storage tank 52, and a hot fluid combination supply and return (hereinafter HS/R) pipe 64 supplies and returns fluid 200 that is hot.

On the roomside equipment side 104, as shown in FIG. 1, the apparatus for refrigeration and heating 20 comprises two structurally identical first and second fan coil units 34A and 34B, respectively. It is to be understood that each of the fan coil units 34A and 34B may be used for refrigeration (cooling mode) when cold fluid is circulated through the coil 43, and the coil may be defrosted by circulating hot fluid through the coil 43 (defrost mode). Whether the fan coil unit 34A, 34B cools or warms depends on the temperature of the fluid 200 being circulated through its coil 43. Each of the first and second fan coil units 34A and 34B comprises a fan motor unit 41 that draws in room air and blows it through the coil 43. The first fan coil unit 34A shows the cooling cycle 36 to cool the first room 90 in which it is placed. The arrows designated D show room air entering the first and second fan coil units 34A, 34B, and the arrows designated E show air exiting the first and second fan coil units 34A and 34B. The first fan coil unit 34A shows the refrigeration cycle where the first room or walk in cooler 90 is refrigerated, and the second fan coil unit 34B shows the defrost cycle 38 wherein the coil 43 of the second fan unit 34B is defrosted so that any accumulated ice thereon melts.

As the first fan coil unit 34A cools the room or walk in cooler (first room 90) it is placed in, its coil 43 will eventually become coated with layers of ice. As time progresses ice will continue to accumulate on the coil 43, and the fan motor unit 41 will blow less and less room air through the coil 43 because the built-up ice decreases air flow. When air circulation is sufficiently impeded, the room 90 will not be adequately cooled because there is no way for cold air to be blown into the first room 90. The ice covered coil 43 needs to be defrosted, and the second fan coil unit 34B in the second room 92 shows the defrost cycle wherein warm fluid 200 is pumped through the coil 43. The melt water flowing off the coil 43 flows to the drain 49. Thus, the present apparatus 20 provides for both refrigeration and heating of a room space or walk in cooler 90, 92, and provides a way by which coil 43 may be defrosted without having to drain the fluid 200 from the apparatus 20.

The cold fluid main pump 3 is positioned in the CS pipe 58 downstream of the evaporator 29 and pumps cold fluid 200 to the first fan coil unit 34A and second fan coil unit 34B. The first fan coil unit 34A is in the refrigeration mode and refrigerates the first room 90. The fan coil unit pump 5 pumps fluid 200 through the coil 43. Fluid 200 is supplied to the coil 43 through an upstream two position three-way valve 12 (designated V1), a modulating three-way mixing valve 13 (designated V2), and a fan coil unit pump 5 that pumps fluid 200 through the coil 43. The fluid exits through a downstream two position three-way valve 14 (designated V3). In a manner to be described presently, the upstream two position three-way valve 12 (designated V1), the modulating three-way mixing valve 13 (designated V2), the fan coil unit pump 5, and the downstream two position three-way valve 14 (designated V3) direct the fluid flow through the first fan coil unit 34A and the amount of fluid moving through the coil 43.

As shown, the cold supply pipe CS 58, the cold return pipe CR 66, and a single hot supply/return pipe HS/R 64 connect to the upstream two position three-way valve 12 (designated V1) to direct hot or cold fluid 200 to first fan coil unit 34A. Because fan coil unit 34A is in the cooling mode, the upstream two position three-way valve 12 (designated V1) directs cold fluid to the a modulating three-way mixing valve designated 13 (designated V2). The fan coil unit pump 5 pumps the cold fluid to the inlet of the coil 43 of first fan coil unit 34A. A fan coil thermostat 74 detects the temperature of the return fluid 200 returning from the fan coil 43 and directs the flow of the return fluid from the coil 43 to the modulating three-way mixing valve 13 (designated V2). The modulating three-way mixing valve 13 (designated V2) is controlled by the fan coil thermostat 74, and can be opened or closed as directed by fan coil thermostat 74. For example, if the fan coil thermostat 74, which is in electronic communication with the first room 90 refrigerated space thermostat 80, detects the first room 90 needs to be rapidly cooled, then the modulating three-way mixing valve 13 (designated V2) is opened such that only cold fluid moves through it and is pumped by the fan coil unit pump 5 through the coil 43. This results in rapid cooling of the air being blown into the first room 90. The return fluid exiting the coil 43 is then directed to the downstream two position three-way valve 14 (designated V3) which directs the fluid to the cold return pipe (CR) 66. As an example of the cooling mode, air designated D entering the fan cooling unit 34A may be at 25 degrees Fahrenheit, and the air designated E exiting the fan coil unit 34A may be at 15 degrees Fahrenheit. The first room or walk in cooler 90 is thus being chilled.

If however, the room 90 is already relatively cold as detected by the refrigerated space thermostat 80, the fan coil thermostat 74 may direct the modulating three-way mixing valve 13 (designated V2) to redirect some or a portion of the flow of fluid that has already circulated through the coil 43 back through the coil 43 again. This recirculation saves on energy consumption, because the cold fluid can be recirculated over and over until it absorbs enough heat energy and reaches a predetermined temperature, at which point the modulating three-way mixing valve 13 (designated V2) closes so that recirculation of the fluid 200 stops and only cold fluid flows through the coil 43. Thus, the fan coil thermostat 74 directs the flow of return fluid from the coil 43 to return to the modulating three-way mixing valve 13 (designated V2). The modulating three-way mixing valve 13 (designated V2) thus allows all, a percentage of, or none of the return fluid from the coil 43 to be recirculated through the coil 43, as directed by the thermostat 74. If no return water is recirculated, it is directed to the downstream two position three-way valve 14 (designated V3) and directed to the cold return CR 66.

As shown in FIG. 1, the exiting cold fluid flows through the cold return pipe CR 66 and may be pumped into the cold fluid storage tank 52 by the cold storage tank pump 9. The cold fluid storage tank thermostat 76 detects the temperature of the cold fluid in the cold fluid storage tank 52. The cold fluid in the cold fluid tank 52 also saves on energy consumption, because fluid from this tank 52, which is already cold, can be pumped by the cold storage tank pump 9 directly to the evaporator 29. Then, the refrigeration machine 24 does not need to expend as much energy to cool the fluid 200 in the evaporator 29. Thus the cold storage tank 52 conserves energy as the load on the refrigeration machine 24 is reduced.

The first fan coil unit 34A is also provided with a total air pressure drop sensor 68. The total air pressure drop sensor 68 detects and measures the total air pressure drop (measured in inches of mercury) across the first fan coil unit 34A. For example, when there is no ice on the coil 43, the total air pressure drop sensor 68 will sense a total air pressure drop across the first fan coil unit 34A of about a quarter of an inch of mercury. Then, over time the total air pressure drop across the coil 43 increases as ice accumulates on the coil 43 and the coil 43 begins to fill with ice. When the total air pressure drop sensor 68 reaches a predetermined maximum pressure differential across the coil 43, which may be about one half inch of mercury, the two position three-way valve 12 (designated V1) automatically closes to the flow of cold fluid, and opens to the flow of hot fluid. Thus, once the predetermined pressure drop is detected, the first fan coil unit 34A automatically switches to the defrost cycle. The defrost cycle is shown with respect to the second fan coil unit 34B.

Defrost Cycle

Shown in FIG. 1 is the second fan coil unit 34B in the defrost cycle/mode 38, wherein warmed fluid is circulated through the second fan coil unit 34B by the fan coil unit pump 6. A thermostat designated T9 81 is disposed in the space that is refrigerated by the second fan coil unit 34B. As described above, when ice accumulates too much on the coil 43, the fan motor unit 41 cannot blow sufficient amounts of air through the coil 43 and the unit 41 ceases to function properly (the second room 92 begins to warm). When this occurs, the coil 43 has to be defrosted so that the fan coil unit 34B will again function properly.

The defrost cycle is similar to the cooling cycle, with one difference being that the temperature of the fluid 200 being circulated through the second fan coil unit 34B coil 43 is hot. As the ice builds up between the coil 43 in the second fan coil unit 34B, air flow through the coil 43 is impeded or blocked, thus resulting in an increase in the pressure drop across the second fan coil unit 34B which is detected by the total air pressure sensor 68. As previously described, upon detecting a predetermined pressure drop which may be, for example, one half inch mercury, the upstream two position three-way valve 17 (designated V6) closes to the flow of cold fluid and opens to the flow of hot fluid as shown in FIG. 1. Hot fluid from the hot supply/return HS/R main 64 then flows through the upstream two position three-way valve 17 (designated V6) and from there through modulating three-way mixing valve 16 (designated V5). The fan coil pump 6 pumps the hot fluid through the coil 43 in second fan coil unit 34B. This hot fluid warms the ice on and between the coil 43 and melts the ice on the coil 43. After exiting the coil 43 the fluid flows through the downstream two position three-way valve 15 (designated V4) and into the hot supply/return pipe 64.

The melt water exits the second fan coil unit 34B and flows into the drain 49. It is noted that the first fan coil unit 34A is also provided with a drain for receiving melt water when it is in the defrost cycle/mode. Thermostat 74 can direct the modulating three-way mixing valve 16 (designated V5) to be closed so that there is no recirculation of hot fluid through the coil 43. This would be for warming of the coil 43 as quickly as possible. Also, as described above in connection with the defrost cycle, the modulating three-way mixing valve 16 (designated V5) will be instructed by the thermostat 74 to open to all of the warm fluid to flow through the coil 43. This would allow warm fluid to deliver all of its heat energy to the coil 43, and at the same time reduce the load on the refrigeration machine 24.

When the fan coil thermostat 74 senses a predetermined temperature of return fluid from the coil 43, for example the return fluid from the coil 43 is about 45 degrees Fahrenheit, it directs the upstream two position three-way valve 17 (designated V6) to close so there is no flow of hot fluid into the coil 43, and open to the flow of cold fluid, thus the second fan coil unit 34B changes over total cold fluid flow automatically. The cold fluid circulated through the coil as previous described, the fan 41 spins, and the space 92 is refrigerated.

Thus, the refrigeration and changeover to defrosting is automatic. A means for computerized control 88 comprising a central processing unit. The means for computerized control 88 may comprise a direct digital controller, which is in electronic communication with the valves V1, V2, V3, V4, V5, and V6, and pumps 4,5, fan coil units 34A, 34B respectively, total pressure drop sensor 68, thermostats 74, and other components of the apparatus 20 may be used to control the apparatus 20. Direct digital controllers 88 known to those having ordinary skill in the art.

Then, the hot fluid flow exiting the second fan coil unit 34B flows through the downstream two position three-way valve 15 (designated V4), and as shown in FIG. 1, flows into the hot supply/return pipe 64. From there, the hot fluid may be directed through the hot supply/return pipe 64 to the salvage energy heat exchanger 40, the hot fluid storage tank 50, or back to the condenser 27.

Also, at times, for example when it is hot outside and the refrigeration machine has to work continuously in order to refrigerate the rooms or spaces 90,92 respectively, or if the needs of the refrigerated rooms 90,92 change, excess heat may build up in the condenser 27. Therefore a an evaporative cooler (heat rejection device) 33 is provided to remove excess condenser 27 heat. The evaporative cooler spray pump 8 pumps cooling water through a pipe. The pipe provides water to sprayers 33A which spray the heat rejection device coil 33B, and this in turn cools the heat rejection device coil 33B. The evaporative cooler fan 32 draws air over the heat rejection device coil 33B, and cooled fluid returns back to the condenser 27. In particular, the evaporative cooler pump 7 pumps fluid from the condenser 27 through the heat rejection device coil 33B where the coil is sprayed (water may be used), and back to the condenser 27. This cooling of condenser 27 fluid can continue as required. During this process, the excess heat could also be used in the building to supply heat where needed, to heat domestic water, to melt snow, and for other purposes.

There is also a salvage energy heat exchanger 40 which receives fluid flow from the hot supply/return pipe 64. Here excess heat energy may be salvaged for use in other applications.

As shown in FIG. 1, the evaporator 29, the condenser 27, evaporative cooler 36, fan coil units 34A and 34B, and salvage energy heat exchanger 40 each employ dedicated pumps (cold fluid evaporator pump 1, hot fluid condenser pump 2, evaporative cooler spray pump 8, fan coil unit pumps 5 and 6, and salvage energy heat exchanger pump 10) for optimum fluid velocity and heat exchange.

It is noted that the cold supply CS 58 and return CR 66 mains are variable volume, which reduces related pump energy consumption.

The apparatus 20 further comprises hot and cold storage tanks 50,52 respectively, in fluid communication with the hot piping loop 60 and the cold piping loop 62, respectively. As shown in FIG. 1, fluid from the hot fluid supply and return pipe HS/R 64, is pumped by the salvage energy heat exchanger pump 10 to the salvage energy heat exchanger 40, which removes heat from the fluid and moves it elsewhere for other uses. The fluid continues through the HS/R pipe 64 and may be directed by hot storage tank pump 11 into the hot storage tank 50, as shown. Hot fluid storage tank thermostat 78 senses the temperature of the fluid in the hot fluid storage tank 50. Then, the fluid may be moved out of the hot fluid storage tank 50 when needed back through the condenser 27 for heating. For example, fluid from tank 50 and/or the hot supply return pipe HS/R 64 may enter the condenser at about 85 degrees Fahrenheit and exit the condenser at about 110 degrees Fahrenheit.

Similarly, cold storage pump 9 moves the cold return fluid through the cold return pipe 66 into the cold storage tank 52. The cold storage tank thermostat 76 senses the temperature in the cold storage tank 52, and this fluid may be moved to the evaporator 29 for chilling when necessary. For example, fluid from tank 52 and/or the cold return CR pipe may be about 22 degrees Fahrenheit, and after flowing through the evaporator 29 exit the evaporator at about 10 degrees Fahrenheit.

Thus, the contents of the hot storage tank 11 and cold storage tank 52 are immediately available for being pumped into the condenser 27 and evaporator 29, respectively. This saves energy, as the refrigeration machine 24 does not need to expend as much energy to achieve the desired hot and cold fluid temperatures.

Also, a feasibility study may be conducted to determine hot and cold storage tank 50, 52 size and refrigeration machine 24 size for optimum cost and optimal energy efficiency and consumption. The study may include such factors as the cooling/heating duty called for, energy cost (demand and use charges, time of day, rates, and so forth) and any constraints associated with the hot and cold storage tanks 50,52, respectively. Such feasibility studies known to those having ordinary skill in the art.

The apparatus 20 further comprises an expansion tank 108 in fluid communication with fluid in the hot supply/return pipe 64 and the fluid in the cold supply pipe 58. An expansion tank pipe 59 connects between the hot supply/return pipe 64 before the suction of the hot fluid main pump 4, and to the cold supply pipe 58 before the suction of cold fluid main pump 3. The fluid in the expansion tank pipes 59 is stagnant. Also, the cold supply pipe 58 ends with a valve 110 that allows a small flow of cold fluid to pass there through or bleed out so that the fluid in the cold supply pipe 58 does not stagnate and warm, but rather it is always being supplied with cold fluid.

Thus, an apparatus for refrigeration and heating 20 is provided which provides first and second fan coil units 34A and 34B either of which may be readily defrosted by pumping hot fluid flow through the coil 43.

### Operation of the Apparatus for Refrigeration and Heating

The equipment is provided with a four (4) position selector switch. This switch has an OFF, a STANDBY, a REFRIGERATION, and a HEATING position. The selector switch is in electronic communication with the means for computerized control 88. The operation of the equipment is as follows:

a) OFF, all the equipment is off (de-energized);

b) STANDBY—The cold fluid evaporator pump 1, the hot fluid condenser pump 2, the cold fluid main pump 3, and the hot fluid main pump 4 are energized. Both the cold piping loop 62 and hot piping loop 60 are active. The pumps, during this part of the sequence, move the fluid to equalize all fluid to an ambient temperature (for example 74 degrees Fahrenheit). When the cold fluid return to evaporator thermostat 70 senses 74 degrees Fahrenheit, the cold storage tank pump 9 is energized to bring the cold fluid tank 52 temperature to about 74 degrees Fahrenheit. When the hot fluid return to evaporator thermostat 72 senses 74 degrees Fahrenheit, the salvage energy heat exchanger pump 10 and the hot storage tank pump 11 are energized to bring the hot fluid tank 50 temperature to about 74 degrees Fahrenheit.

c) REFRIGERATION—The cold fluid evaporator pump 1, the hot fluid condenser pump 2, the cold fluid main pump 3, and the hot fluid main pump 4 are energized. The refrigeration machine 24 is energized to bring the cold fluid piping loop 62 to about 10 degrees Fahrenheit. At this time the first fan coil unit 34A and second fan coil unit 34B are energized, and refrigeration space thermostat 80, total pressure sensor 68, fan motor unit 41, and the two position three-way valves 12 (designated V1), 0.14 (designated V3), 15 (designated V4), and 17 (designated V6), on the first and second fan coil units 34A and 34B, respectively, allow for fluid flow. With the first and second fan coil units 34A and 34B activated, the cold fluid will warm from 10 degrees Fahrenheit to 22 degrees Fahrenheit. If the fluid return temperature is below 22 degrees Fahrenheit, the cold storage tank pump 9 starts and cold fluid tank 52 temperature decreases from 74 degrees Fahrenheit to a temperature of between 10 degrees Fahrenheit and 22 degrees Fahrenheit. If the cooling demand is low, the temperature of the fluid in the tank 52 could drop down to 10 degrees Fahrenheit. At this point, the refrigeration machine 24 will unload to a minimum or even stop, and the cold tank 52 fluid may carry the cooling load until the fluid in the cold return CR 66 rises to 22 degrees Fahrenheit. At that point the refrigeration machine 24 starts and loads and unloads heat energy to maintain the fluid return temperature to the evaporator 29 of about 22 degrees Fahrenheit. The cold fluid evaporator pump 1, the hot fluid condenser pump 2, the cold fluid main pump 3, the cold storage tank pump 9 remain activated.

During this refrigeration sequence the hot fluid in the hot fluid piping loop 60 is under the control of hot fluid return to condenser thermostat 72 to maintain 85 degree Fahrenheit return temperature to the condenser 27. When the hot fluid from the hot fluid piping loop 60 rises from 74 degrees to 85 degrees Fahrenheit the hot storage pump 11 is energized to warm the hot fluid tank 50 from 74 degrees to 85 degrees. When the hot fluid in the hot fluid piping loop 60 rises above 85 degrees pump 10 is energized to provide heating output from the salvage energy heat exchanger 40. If the temperature of the fluid in the hot fluid piping loop 60 continues to rise, the evaporative cooler pump 7 and the evaporative cooler fan 32 are energized in sequence with spray pump 8 to maintain 85 degrees Fahrenheit return fluid temperature to the condenser 27.

D. HEATING—The first and second fan coil units 34A and 34B, respectively, are energized to continue satisfying the refrigerated space thermostats 80,81, respectively. Operation of the cold fluid loop 62 is as described above. The salvage heat exchanger thermostat 82 is used to increase the heating output from the salvage energy heat exchanger 40. The salvage heat exchanger thermostat 82 will override the hot fluid return to condenser thermostat 72 to drive the condenser 27 outlet temperature to 110 degrees Fahrenheit. If the salvage heat exchanger thermostat 82 temperature rises above 108 degrees Fahrenheit, the hot storage tank pump 11 is energized to heat the fluid in the hot fluid tank 50 to 110 degrees Fahrenheit. If the salvage heat exchanger thermostat 82 senses the temperature continuing to rise, then evaporative cooler pump 7 and evaporative cooler fan 32 are energized in sequence with spray pump 8, to maintain a 108 degree Fahrenheit supply temperature from the salvage energy heat exchanger 40 to the external heating loads.

It will be appreciated by those skilled in the art that while the apparatus for refrigeration and heating has been described above in connection with particular embodiments and examples, the apparatus for refrigeration and heating is not necessarily so limited and other embodiments, examples, uses, and modifications and departures from the embodiments, examples, and uses may be made without departing from the apparatus for refrigeration and cooling. All of these alternative embodiments are intended to be within the scope and spirit of the this invention.

What is claimed:

1. An apparatus for refrigeration and heating comprising:
a) a cold supply pipe for delivering cold fluid, a cold return pipe for returning cold fluid, and a hot supply/return pipe for delivering and returning hot fluid,
b) an upstream two position three-way valve connected to the cold supply pipe and to the hot supply/return pipe, a modulating three-way mixing valve located downstream of the upstream two position three-way valve,
c) a fan coil unit pump located downstream of the modulating three-way mixing valve,
d) a fan coil unit comprising a coil and a fan for blowing air through the coil and the fan coil unit pump for pumping fluid through the coil,
e) a fan coil unit pump located downstream of the modulating three-way mixing valve wherein the modulating three-way mixing valve is for allowing none, a portion of, or all of the fluid in the coil to be recirculated through the coil by the fan coil unit pump,
f) a downstream two position three-way valve located downstream of the modulating three-way mixing valve and for returning fluid to the cold return pipe or the hot supply/return pipe,
g) a means for computerized control,
h) a total air pressure drop sensor to detect a pressure differential across the coil and to sense a predetermined maximum pressure differential across the coil, the total air pressure sensor in electronic communication with the means for computerized control.

2. The apparatus for refrigeration and heating according to claim 1 wherein when the total air pressure drop sensor detects a pressure differential across the coil less than about one half of inch mercury the upstream two position three-way valve connected to the cold supply pipe is instructed to open to the flow of cold fluid, and the modulating three-way mixing valve is instructed to open to the flow of cold fluid by the means for computerized control, and the fan coil unit pump pumps the cold fluid through the coil.

3. The apparatus for refrigeration and heating according to claim 1 wherein the predetermined maximum pressure drop across the coil is about one half inch mercury.

4. The apparatus for refrigeration and heating according to claim 3 wherein when the predetermined maximum pressure drop across the coil is reached, the means for computerized control instructs the upstream two position three-way valve to open to the flow of hot fluid for melting any accumulated ice on the coil.

5. The apparatus for refrigeration and heating according to claim 4 further comprising a fan coil thermostat for detecting the temperature of the fluid exiting the coil and in communication with the means for computerized control, and wherein the upstream two position three way valve closes to the flow of hot fluid when the fan coil thermostat detects the temperature of the fluid exiting the coil is about 45 degrees Fahrenheit.

6. The apparatus for refrigeration and heating according to claim 5 wherein when the temperature of about 45 degrees Fahrenheit is detected, the upstream two position three way valve opens to the flow of cold fluid.

7. The apparatus for refrigeration and heating according to claim 1 further comprising a refrigeration machine for comprising a condenser and an evaporator, and the condenser is connected to the hot supply/return pipe and the evaporator is connected to the cold supply pipe, and a cold return pipe connected to the evaporator.

8. The apparatus for refrigeration and heating according to claim 5 further comprising a cold fluid storage tank for storing cold fluid and a hot fluid storage tank for storing hot fluid.

9. The apparatus for refrigeration and heating according to claim 1 further comprising:
a) a heat rejection device comprising an evaporative cooler comprising fan and a heat rejection coil,
b) an evaporative cooler pump for pumping hot fluid from the condenser through the heat rejection coil,
c) sprayers for spraying the heat rejection coil with water to cool the hot fluid before it is returned to the condenser.

10. The apparatus for refrigeration and heating according to claim 1 wherein the fluid comprises one or more of synthetic fluids, ethylene glycol mixed with water, eutetic mixtures of phenyl ether and diphenyl, isomers of an alkylated aromatic, and blends thereof.

11. A three pipe cooling and heating apparatus for cooling a room comprising:
a) a refrigeration machine comprising a condenser and an evaporator,
b) a cold supply pipe leading from the evaporator and a combination hot supply/return pipe leading from the condenser,
c) a fan coil unit comprising a coil and, a fan coil pump for circulating fluid through the fan coil unit, the fan for blowing room air across the coil, the fan coil unit operable between a cooling mode wherein a cold fluid is circulated through the coil by the fan coil pump and a heating mode wherein hot fluid is circulated through the coil by the fan coil pump,
d) the cold supply pipe and hot supply return pipe leading to a two position three-way valve,
e) a modulating three-way mixing valve located at a downstream location from the two position three-way valve, a fan coil thermostat in a controlling type relationship with the modulating three-way mixing valve,
f) the modulating valve for directing the flow of the fluid pumped by the fan coil pump so that all, none, or a percentage of the fluid being pumped by the fan coil pump is recirculated the fan coil unit,
g) a total pressure drop sensor positioned to detect a total pressure drop across the coil an wherein if the total pressure drop reaches about one half and inch of mercury hot fluid is circulated through the coil to melt accumulated ice.

12. A three pipe cooling and heating apparatus for cooling a room comprising according to claim 11 further comprising a heat rejection device for removing excess heat from the apparatus.

13. A three pipe cooling and heating apparatus for cooling a room according to claim 11 further comprising a salvage heat exchanger thermostat and a salvage heat exchanger controlled by the thermostat, the salvage heat exchanger for removing heat.

14. A method of refrigerating and cooling comprising the following acts:
a) providing a cold supply pipe for delivering cold fluid, providing a cold return pipe for returning cold fluid, and providing a hot supply/return pipe for delivering and returning hot fluid,
b) providing an upstream two position three-way valve connected to the cold supply pipe and to the hot supply/return pipe, and locating a modulating three-way mixing valve located downstream of the upstream two position three-way valve,
c) positioning a fan coil unit pump downstream of the modulating three-way mixing valve,
d) providing a fan coil unit comprising a coil and a fan and blowing air through the coil with the fan the fan coil unit pump for pumping fluid through the coil,
e) providing a fan coil unit pump located downstream of the modulating three-way mixing valve wherein the modulating three-way mixing valve is for allowing none, a portion of, or all of the fluid in the coil to be recirculated through the coil by the fan coil unit pump,
f) positioning a downstream two position three-way valve downstream of the modulating three-way mixing valve for returning fluid to the cold return pipe or the hot supply/return pipe,
g) providing a means for computerized control,
h) providing a total air pressure drop sensor for detecting a pressure differential across the coil and for sensing a predetermined maximum pressure differential across the coil, the total air pressure sensor in electronic communication with the means for computerized control.

15. The method of refrigeration and cooling according to claim 14 comprising the further acts detecting a pressure differential across the coil less than about one half of inch mercury and opening the upstream two position three-way valve connected to the cold supply pipe to the flow of cold fluid, and opening the modulating three-way mixing valve to the flow of cold fluid and pumping the cold fluid through the coil.

16. The method of refrigeration and heating according to claim 14 comprising the further act of setting the predetermined maximum pressure drop across the coil to be about a one half inches of mercury.
